(19) United States
(12) Patent Application Publication
(10) Pub. No.: US 2025/0268418 A1
(43) Pub. Date: Aug. 28, 2025

(54) Water Heating Apparatus and System for Aircraft Beverage Maker

(71) Applicant: The Boeing Company, Arlington, VA (US)

(72) Inventors: Nikhil Anthony Saldanha, Bangalore (IN); Ajay Alwar, Bangalore (IN)

(21) Appl. No.: 18/588,404

(22) Filed: Feb. 27, 2024

(51) Int. Cl. A47J 31/54; B64D 11/00

(52) U.S. Cl. CPC A47J 31/542; B64D 11/0007

(57) ABSTRACT

Present aspects are directed to apparatuses, systems, and methods that provide the rapid, inline heating of small-water volumes provided in a continuous water flow from an onboard water supply to the inline heating apparatus having a small footprint for use in associated aircraft beverage makers in a vehicle galley of a vehicle that can include aircraft.

### TECHNOLOGICAL FIELD

The present disclosure relates generally to the field of beverage makers. More specifically, the present disclosure relates to the field of beverage makers for use in vehicle galleys, and/or in galley inserts.

### BACKGROUND

Beverage makers, including beverage makers on vehicles typically comprise a water tank or container in communication with a water heater that is responsible for heating a stagnant water volume held in a container to a temperature conducive for preparing hot beverages. Such tank-based beverage makers can heat and maintain a stagnant water volume within an internal tank to dispense the heated water when required by the user, for example, into a carafe having a stagnant volume of about 1.5 liters. Typical beverage makers on vehicles that can be in contact with a heating element for prolonged periods can undergo “scaling” at the water-heating element surface that can impact power draws of the beverage maker and that can further contribute to substandard beverage results, at least in terms of, for example, taste.

Unless explicitly identified as such, no statement herein is admitted as prior art merely by its inclusion in the Technological Field and/or Background section.

### SUMMARY

Present aspects are directed to methods, systems, and apparatuses for the rapid heating of a small water volume through an inline water heater assembly (referred to equivalently herein as “flow through heater assemblies” and/or “tankless heater assemblies”) that can be integrated into or placed in communication with a beverage maker, including beverage makers of the type included in a vehicle galley or galley insert that can include an aircraft galley of an aircraft.

A present aspect is directed to an apparatus for heating a liquid for a beverage maker, with the apparatus including an inline water heater assembly in communication with a water supply. The inline water heater assembly includes an assembly water inlet block, with the assembly water inlet block including an assembly water inlet block inlet in communication with the water supply. The water inlet block further includes an assembly water inlet block internal pathway, with the assembly water inlet block internal pathway including one or more assembly water inlet block internal pathway inlets and one or more assembly water inlet block internal pathway outlets. The inline assembly water heater further includes an assembly water outlet block, with the assembly water outlet block including an assembly water outlet block outlet in communication with the beverage maker. The assembly water outlet block further includes an assembly water outlet block internal pathway, with the assembly water outlet block pathway further including one or more assembly water outlet block internal pathway inlets, and one or more assembly water inlet block internal pathway outlets. The inline water heater assembly further includes a tube assembly including a tube assembly first end and a tube assembly second end, with the tube assembly first end positioned adjacent to the assembly water inlet block, and with the tube assembly second end positioned adjacent to the assembly water outlet block. The tube assembly further includes a plurality of outer tubes, with the plurality of outer tubes including an outer tube inner surface and an outer tube outer surface, and with the plurality of outer tubes further including an outer tube inner diameter (D1). The tube assembly further includes a plurality of inner tubes, with plurality of inner tubes including an inner tube inner surface, and an inner tube outer surface. The inner tube outer surface includes one or more directional channel, with the one or more directional channel each including a directional channel wall including a directional channel wall outer edge, with the one or more directional channel further including a directional channel base, with the directional channel base bounded by adjacent directional channel walls. The one or more directional channel is bounded by the directional channel base, the directional channel walls, and a portion of the outer tube inner surface. Each of the plurality of inner tubes includes an inner tube inner diameter (D2), with each of the plurality of inner tubes further including an inner tube outer diameter (D3) extending between opposing directional channel wall outer edges that are positioned 180 degrees from one another. The inner tube outer diameter (D3) is substantially equivalent to the outer tube inner diameter (D1). The inline water heater assembly further includes a plurality of heater rods, with the plurality of heater rods including a heater rod outer surface and a heater rod outer surface diameter (D4) that is substantially equivalent to the inner tube inner diameter (D2), with one of the plurality of heater rods each positioned within one of the plurality of inner tubes. The one or more directional channel is in fluid communication with the assembly water inlet block internal pathway, with the one or more directional channel further in fluid communication with the assembly water outlet block internal pathway.

In another present aspect, the inline water heater assembly further includes a weld-free water-tight seal at the tube assembly first end/assembly water inlet block interface, and further includes a weld-free water-tight seal at the tube assembly second end/assembly water outlet block interface.

In another present aspect, the weld-free water-tight seal comprises at least one of a sealant material and an O-ring.

In another present aspect, the inline water heater assembly is configured to contain a maximum total fluid volume ranging from about 10 ml to about 25 ml.

In a further present aspect, each of the one or more directional channel is a liner channel along the length of the directional channel.

In another aspect, the one or more directional channel is a helical channel about the length of the inner tube outer surface.

In another aspect, the one or more directional channel is a single helical channel.

In another present aspect, the tube assembly and the heater rods are substantially cylindrical.

A further present aspect is directed to a beverage maker including the inline water heater assembly integrated into the beverage maker.

A further present aspect is directed to a beverage maker including the integrated inline water heater assembly within a beverage maker footprint.

Another present aspect is directed to a vehicle including the beverage maker with the integrated inline water heater assembly.

Another present aspect is directed to an aircraft galley insert that includes the present inline water heater assembly.

Another present aspect is directed to an aircraft galley insert that includes the present beverage maker with the integrated inline water heater assembly.

A further present aspect is directed to an aircraft that comprises an aircraft galley insert that includes the present inline water heater assembly.

Another present aspect is directed to an aircraft that includes the present beverage maker with the integrated inline water heater assembly.

Another present aspect is directed to a system for heating water in a beverage maker with the system including a water supply, and an inline water heater assembly in communication with the water supply. The inline water heater assembly includes an assembly water inlet block, with the assembly water inlet block including an assembly water inlet block inlet in communication with the water supply. The water inlet block further includes an assembly water inlet block internal pathway, with the assembly water inlet block internal pathway including one or more assembly water inlet block internal pathway inlets and one or more assembly water inlet block internal pathway outlets. The inline assembly water heater further includes an assembly water outlet block, with the assembly water outlet block including an assembly water outlet block outlet in communication with the beverage maker. The assembly water outlet block further includes an assembly water outlet block internal pathway, with the assembly water outlet block pathway further including one or more assembly water outlet block internal pathway inlets, and one or more assembly water inlet block internal pathway outlets. The inline water heater assembly further includes a tube assembly including a tube assembly first end and a tube assembly second end, with the tube assembly first end positioned adjacent to the assembly water inlet block, and with the tube assembly second end positioned adjacent to the assembly water outlet block. The tube assembly further includes a plurality of outer tubes, with the plurality of outer tubes including an outer tube inner surface and an outer tube outer surface, and with the plurality of outer tubes further including an outer tube inner diameter (D1). The tube assembly further includes a plurality of inner tubes, with plurality of inner tubes including an inner tube inner surface, and an inner tube outer surface. The inner tube outer surface includes one or more directional channel, with the one or more directional channel each including a directional channel wall including a directional channel wall outer edge, with the one or more directional channel further including a directional channel base, with the directional channel base bounded by adjacent directional channel walls. The one or more directional channel is bounded by the directional channel base, the directional channel walls, and a portion of the outer tube inner surface. Each of the plurality of inner tubes includes an inner tube inner diameter (D2), with each of the plurality of inner tubes further including an inner tube outer diameter (D3) extending between opposing directional channel wall outer edges that are positioned 180 degrees from one another. The inner tube outer diameter (D3) is substantially equivalent to the outer tube inner diameter (D1). The inline water heater assembly further includes a plurality of heater rods, with the plurality of heater rods including a heater rod outer surface and a heater rod outer surface diameter (D4) that is substantially equivalent to the inner tube inner diameter (D2), with one of the plurality of heater rods each positioned within one of the plurality of inner tubes. The one or more directional channel is in fluid communication with the assembly water inlet block internal pathway, with the one or more directional channel further in fluid communication with the assembly water outlet block internal pathway. The system further includes a power supply in communication with the plurality of heater rods, and wherein the one or more directional channel is in fluid communication with the assembly water inlet block internal pathway, and the one or more directional channel is further in fluid communication with said assembly water outlet block internal pathway.

In another present aspect, the power supply is configured to provide power to the plurality of heater rods at a wattage ranging from about 1500 W to about 2700 W.

In another present aspect, the water supply is configured to deliver a water flow from the water supply to the inline water heater assembly at an ambient water flow temperature ranging from about 45° F. to about 100° F., and wherein the water flow is configured to exit the inline water heater assembly as a heated water flow comprising a heated water flow comprising a temperature ranging from about 180° F. to about 205° F., with the water flow comprising a resident duration time in the inline water heater assembly ranging from about 0.5 to about 1.0 min.

In another present aspect, the inline water heater assembly is configured to contain a maximum total fluid volume ranging from about 10 ml to about 25 ml.

In another present aspect, the inline water heater assembly is configured to deliver and/or dispense a temperature-consistent water flow at a temperature ranging from about 180° F. to about 205° F. that can accumulate to a total delivered heated water flow to a volume of about 2 liters within a time duration of ranging from about 3 min. to about 4 min.

In another present aspect, inline water heater assembly is configured to deliver and/or dispense a temperature-consistent water flow at a temperature ranging from about 180° F. to about 205° F. at a flow rate of about 1 liter per 2 min.

In another present aspect, inline water heater assembly is configured to deliver and/or dispense a substantially continuous temperature-consistent water flow at a temperature ranging from about 180° F. to about 205° F. at a flow rate of about 1 liter per 2 min.

A further present aspect is directed to a vehicle comprising the presently disclosed system.

Another present aspect is directed to an aircraft comprising the presently disclosed system.

A further present aspect is directed to a method for heating water from a water supply for a beverage maker, with the method including delivering a water flow from a water supply, including water having an ambient temperature ranging from about 45° F. to about 100° F., to an inline water heater assembly of the beverage maker. The inline water heater assembly includes an assembly water inlet block, with the assembly water inlet block including an assembly water inlet block inlet in communication with the water supply. The water inlet block further includes an assembly water inlet block internal pathway, with the assembly water inlet block internal pathway including one or more assembly water inlet block internal pathway inlets and one or more assembly water inlet block internal pathway outlets. The inline assembly water heater further includes an assembly water outlet block, with the assembly water outlet block including an assembly water outlet block outlet in communication with the beverage maker. The assembly water outlet block further includes an assembly water outlet block internal pathway, with the assembly water outlet block pathway further including one or more assembly water outlet block internal pathway inlets, and one or more assembly water inlet block internal pathway outlets. The inline water heater assembly further includes a tube assembly including a tube assembly first end and a tube assembly second end, with the tube assembly first end positioned adjacent to the assembly water inlet block, and with the tube assembly second end positioned adjacent to the assembly water outlet block. The tube assembly further includes a plurality of outer tubes, with the plurality of outer tubes including an outer tube inner surface and an outer tube outer surface, and with the plurality of outer tubes further including an outer tube inner diameter (D1). The tube assembly further includes a plurality of inner tubes, with plurality of inner tubes including an inner tube inner surface, and an inner tube outer surface. The inner tube outer surface includes one or more directional channel, with the one or more directional channel each including a directional channel wall including a directional channel wall outer edge, with the one or more directional channel further including a directional channel base, with the directional channel base bounded by adjacent directional channel walls. The one or more directional channel is bounded by the directional channel base, the directional channel walls, and a portion of the outer tube inner surface. Each of the plurality of inner tubes includes an inner tube inner diameter (D2), with each of the plurality of inner tubes further including an inner tube outer diameter (D3) extending between opposing directional channel wall outer edges that are positioned 180 degrees from one another. The inner tube outer diameter (D3) is substantially equivalent to the outer tube inner diameter (D1). The inline water heater assembly further includes a plurality of heater rods, with the plurality of heater rods including a heater rod outer surface and a heater rod outer surface diameter (D4) that is substantially equivalent to the inner tube inner diameter (D2), with one of the plurality of heater rods each positioned within one of the plurality of inner tubes. The one or more directional channel is in fluid communication with the assembly water inlet block internal pathway, with the one or more directional channel further in fluid communication with the assembly water outlet block internal pathway. The method further includes circulating the water flow within the inline water heater assembly along the one or more directional channel of each of the at least one of the plurality of inner tubes at the inner tube outer surface, heating the water flow within the inline water heater assembly to form a heated water flow, with the heated water flow having a temperature ranging from about 180° F. to about 205° F., and releasing the heated water flow from the assembly water outlet block, wherein the water flow is heated within the inline water heater assembly from the ambient temperature ranging from about 45° F. to about 100° F. to a heated water flow temperature ranging from about 180° F. to about 205° F. within a time duration ranging from about 0.5 min to about 1.0 min., and wherein said inline water heater assembly is configured to comprise a total water volume of the water flow within the inline water heater assembly ranging from about 10 ml to about 25 ml.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

Having thus described variations of the disclosure in general terms, reference will now be made to the accompanying drawings, which are not necessarily drawn to scale, and wherein:

FIG. 1 is an illustration of a vehicle in the form of an aircraft, according to present aspects;

FIG. 2A is an illustration of an overhead plan view of a partially exposed vehicle in the form of an aircraft that can be of the type shown, for example in FIG. 1, according to present aspects;

FIG. 2B is a box diagram illustrating a vehicle that can be in form of an aircraft comprising a vehicle galley and a beverage maker within the vehicle galley and/or galley insert, with the present vehicle that can be in the form of an aircraft that can be of the type shown in FIGS. 1 and 2A, according to present aspects;

FIG. 3A is an exploded view of a present inline water heater apparatus and system, according to present aspects;

FIG. 3B is a cross-sectional end view of one of the plurality of inner tubes of the present water heater apparatus and system, according to present aspects;

FIG. 3C is an end-view of a heater rod heating element having a diameter, D4, according to present aspects;

FIG. 3D is an exploded view of a variation of an inline water heater assembly, according to present aspects;

FIG. 4 is an exploded view of a portion of the present water heater apparatus and system that can be of the type shown in FIG. 3A, according to present aspects;

FIG. 5A is an enlarged partial cross-sectional end view of a present inlet (“start”) block of a present inline water heater apparatus and system that can be of the type according to present aspects;

FIG. 5B is an enlarged partial cross-sectional end view of a present outlet (“end”) block of a present inline water heater apparatus and system that can be of the type according to present aspects;

FIG. 6A is a perspective view of a present assembled inline water heater apparatus and system, according to present aspects;

FIG. 6B is a perspective view of a present assembled inline water heater apparatus and system, according to present aspects;

FIG. 7A is partial cross-sectional side view of a present assembled inline water heater apparatus and system, according to present aspects;

FIG. 7B is partial cross-sectional side view of a present assembled inline water heater apparatus and system, according to present aspects;

FIG. 8A is an exploded view of an alternate present inline water heater apparatus and system, according to present aspects;

FIG. 8B is an exploded view of an alternate present inline water heater apparatus and system, according to present aspects; and

FIG. 9 is a flowchart outlining a present method, according to present aspects.

### DETAILED DESCRIPTION

Present aspects are directed to apparatuses, system, and methods for significantly improving the heating and delivery of hot water to a beverage maker located within a vehicle that can include, for example, a beverage maker located within a galley insert of an aircraft galley of an aircraft.

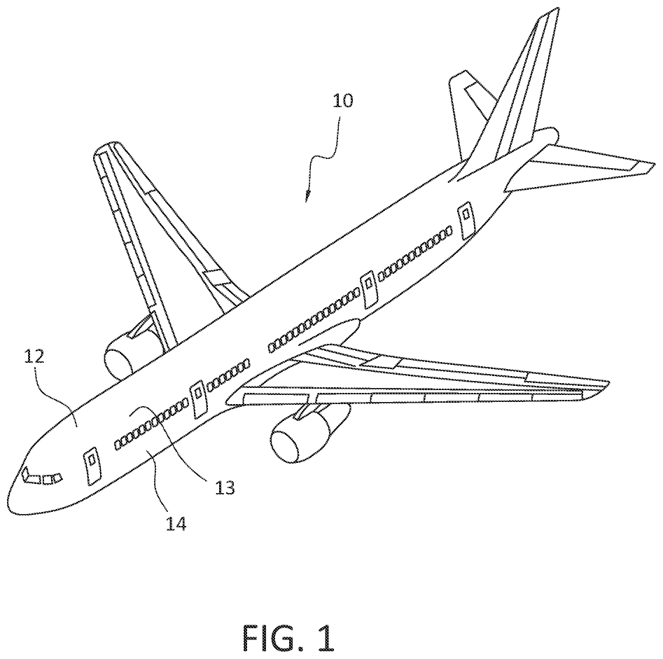

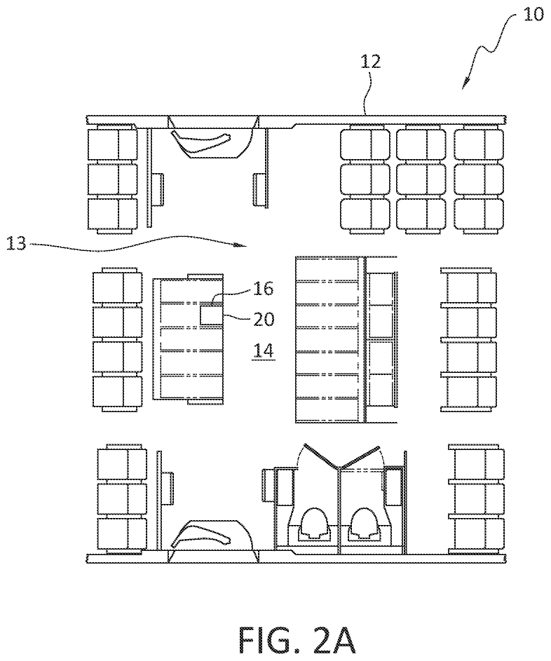

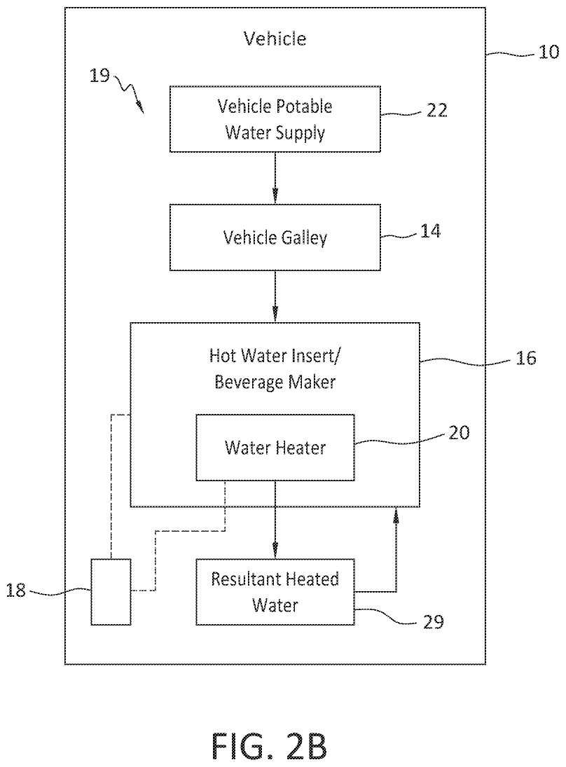

FIG. 1 is an illustration of a vehicle in the form of an aircraft 10, according to present aspects, having a fuselage 12, and further comprising a passenger cabin 13 and a galley area located within the passenger cabin 13. A galley 14 can comprise one or more galley inserts with at least one galley insert configured to include at least one beverage maker 16 (shown, for example, in FIG. 2A) in the galley area 14.

FIG. 2A is an overhead exposed view of aircraft 10 that can be of the type shown in FIG. 1, according to present aspects, and further a layout of a passenger cabin 13 comprising a galley 14 (referred to equivalently herein as a “galley area”) that can comprise one or more galley inserts with at least one being a beverage maker 16.

FIG. 2B is a box diagram showing a vehicle that can be in the form of an aircraft 10 comprising galley area 14 that can comprise one or more galley inserts where at least one galley insert can comprise a system 19 comprising a beverage maker 16 in communication with or integral with an inline water heater assembly 20 (referred to equivalently herein as “water heater assembly”, “water heating assembly”). As shown in FIG. 2B, the beverage maker 16 can integrally comprise the water heater assembly 20 as an integrated or integral inline water heater assembly.

A power source 18 (referred to equivalently herein as a “power supply”) is shown in communication with the in line water heater assembly 20, with the power source further in communication with: 1) the beverage maker 16; and/or 2) the water heater assembly 20 that is integral with beverage maker 16, or that can otherwise be in communication with inline water heater assembly 20. When the water heater assembly 20 is integral with or otherwise contained within beverage maker 16, the power source 18 can be in communication with the beverage maker with internal electrical lines/connections present within the beverage maker to power the electrical heating elements of the water heater assembly 20. In another present example (not specifically shown in FIG. 2B), the water heater assembly can be located remotely from, and in communication with the beverage maker, and/or remotely from and in communication with a galley insert. In another present example, the water heater assembly can provide heated water to other locations that can be galley locations within or outside of one or more galley inserts.

As further shown in FIG. 2B, aircraft 10 can further comprise a water supply 22 (referred to equivalently herein as a “potable water supply”) that can be, for example, a container, vessel, tank, etc., located remotely from the galley area in the aircraft (or that can be located, for example, in the galley area, with the water supply 22 in communication with the water heater assembly 20. In one example, the water supply can be directed to a galley, and/or a galley insert located within a galley area, via water lines (e.g.; tubing, etc.) that route water from the water supply to the galley inserts, including the galley inserts that can contain a beverage maker comprising the present inline water heater assembly, with present aspects further comprising water lines routing water from the water supply to an inlet connector in communication with the present inlet blocks of the present inline water heater assemblies.

While the heater rods, the inner tubes, and the outer tubes of the present water heater assemblies are shown in the FIGs. as substantially cylindrical in shape along their length, present aspects contemplate the three components having any longitudinal geometric shape along their length, so long as the three components are dimensioned to be assembled together and that, when assembled together, comprise a conforming adjacent fit with respect to at least the heater rods and the inner tubes, with adjacently located components in an assembled state having a fit of close tolerance and that can be easily disassembled from one another. That is, the heater rods, inner tubes, and outer tubes may have a rectangular, or hexagonal, or triangular, or other cross-sectional geometric shape, so long as they together form into an assembled state with virtually no space between and along the length of adjacent components in the assembled state, at least for purposes of forming a highly efficient heat transfer between the heater rods and the inner tubes, and such that the directional channels at the inner tube outer surface/outer tube inner tube interface provide a substantially water-tight seal for the water flow traversing and otherwise proceeding through the present inline water heater assemblies.

In addition, according to present aspects, the present inline water heater assemblies can have a weld-free configuration that can significantly assist in the apparatus' assembly, and disassembly (e.g., for maintenance, component replacement, and/or inspection, etc.) For example, if only one heater rods requires removal/replacement and/or maintenance, individual heater rods can be replaced from and reinserted into the assembly, resulting in a significantly more cost-effective operation of the heater assembly. In addition, when the present inline water heater assembly is integrated into, for example, a beverage maker, the components of the heater assembly, being in a weld-free design, can be individually replaced or individually repaired, obviating the need for replacement of the entire beverage maker, or of the entire inline water heater assembly, for example.

As will be described in more detail herein, and shown in the FIGs. the present inline water heater assembly can comprise and otherwise implement the use of O-rings between components to effect a water-tight seal and otherwise inhibit leakage from the water heater assembly. In other examples, the present water heater assembly can incorporate or otherwise comprise a sealant (e.g., a silicone sealant) applied at component interfaces to effect a water-tight seal. While present component interfaces can also include a chemical bonding or welding to join component parts and effect a water-tight seal, the use of sealant and or O-rings at component interfaces are preferred, and presented herein as advantageous aspects that do not establish permanent joining through, for example, welding and/or chemical bonding, etc.

The use of O-rings is further preferred over applied sealant at least to streamline and economize assembly manufacture, installation, maintenance, removal, and replacement. In addition, the strategic placement of O-rings as seals in the present assemblies further decreases assembly manufacture time, as the O-rings obviate the “cure time” delay that may be incurred through the use of curable sealant materials. The present FIGS. illustrate present assemblies that incorporate either O-rings or sealant to achieve the desired water-tight seals.

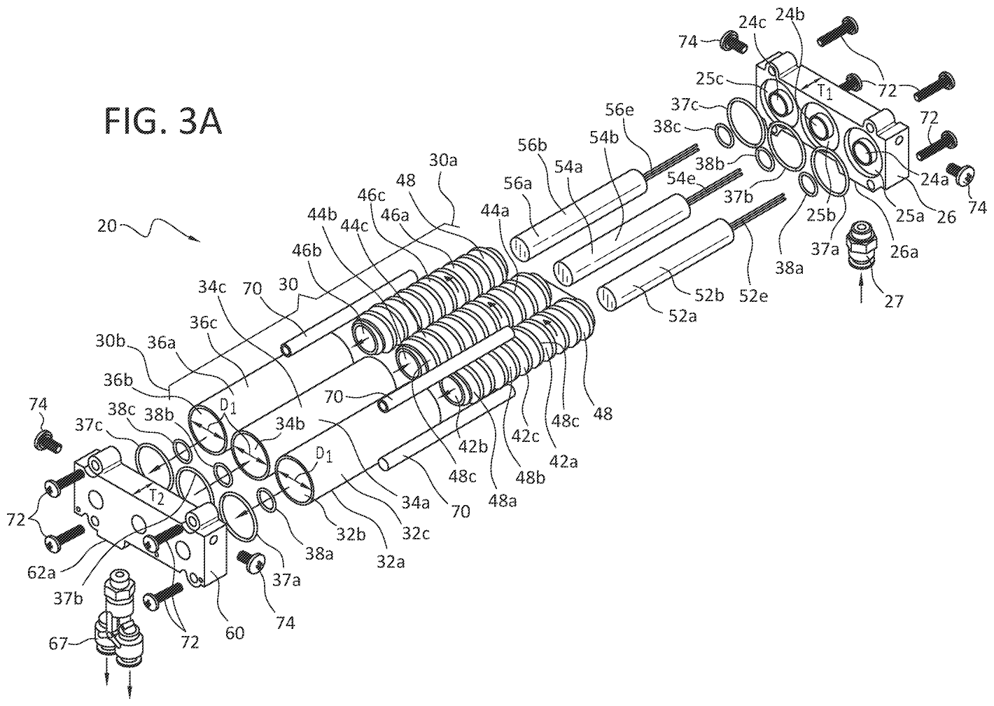

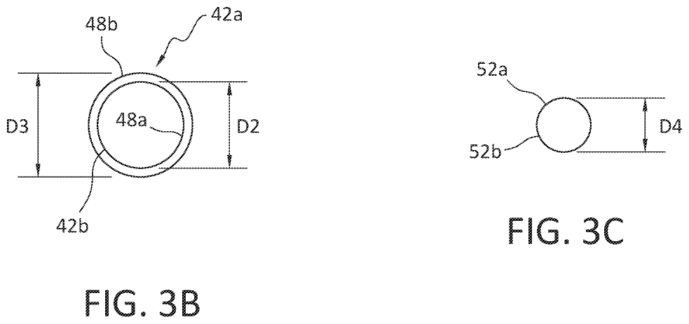

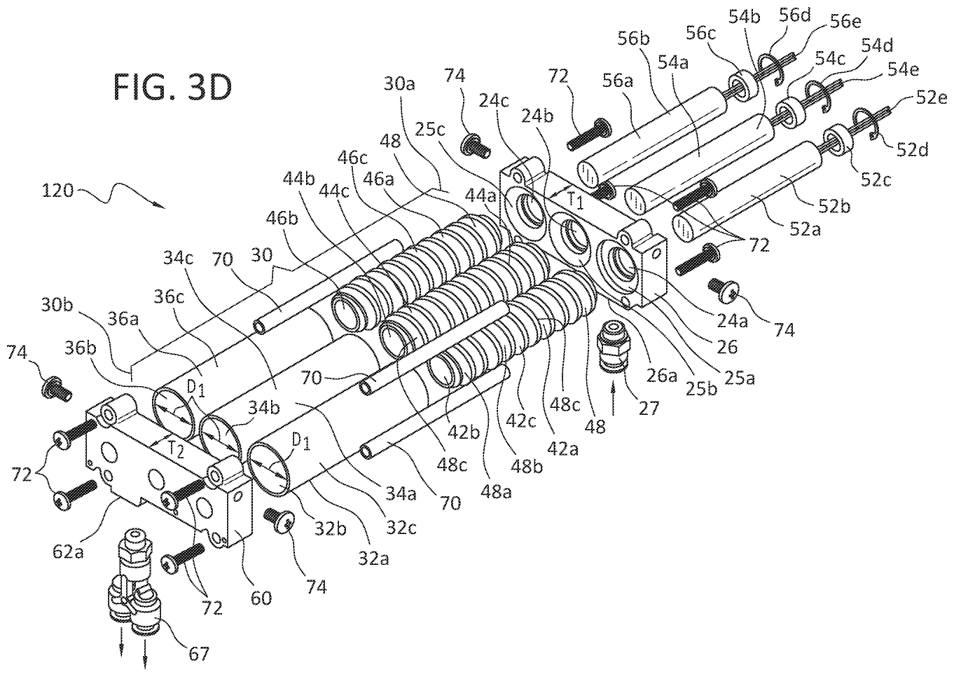

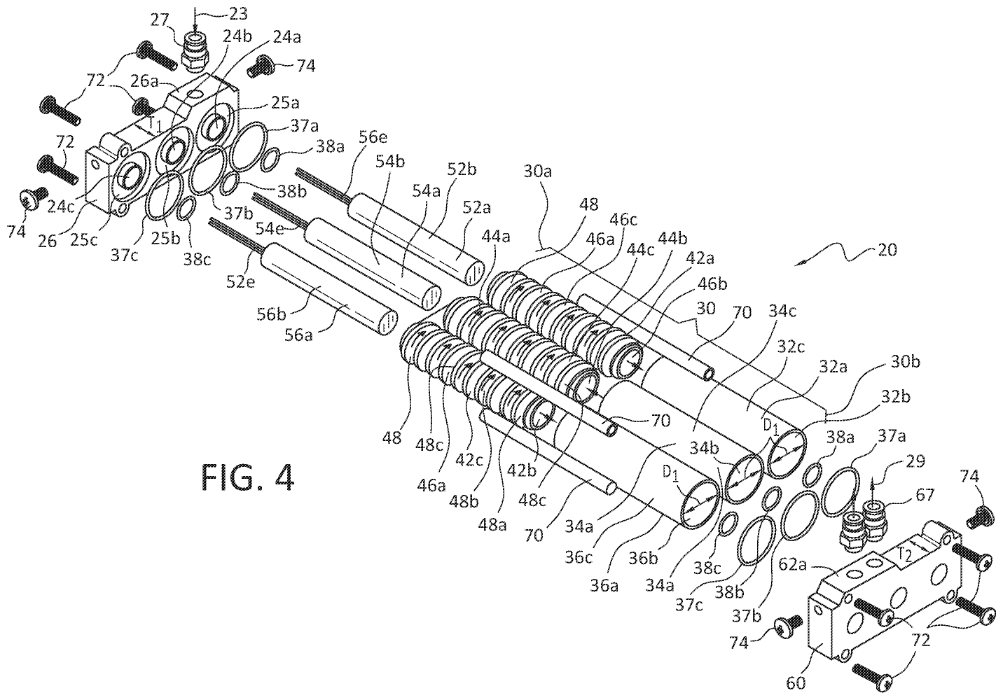

FIG. 3A is an exploded view of a water heater assembly 20 in a disassembled state, according to a present aspect, with O-rings present in the assembly to effect a water-tight seal. As shown in FIG. 3A, water heater assembly 20 comprises an assembly water inlet block 26, with assembly water inlet block shown in more detail in FIGS. 4, 5A, 6A, 6B, 7A, and 7B, and referred to equivalently herein as a “start block”. Water inlet block 26 is configured to receive an ambient temperature water flow from as water supply into the water inlet block and directs the admitted water flow through the water inlet block and into and through the inline water heater assembly. The water inlet block 26 comprises a plurality of water inlet block heater rod openings 24a, 24b, 24c that are configured to be spaced a selected distance apart from one another.

As shown in the FIGs. the assembly water inlet block 26 can comprise a number of assembly water inlet block openings totaling three (3) heater rod openings to accommodate the entry of, and to otherwise receive into each opening a heater rod (referred to equivalently herein as “heater element”, “heating element”) at one side of the assembly water inlet block, with the number of heater rod openings present through the thickness (T1) of the assembly water inlet block understood to correspond to the number of heater rods selected for use in the water heater assembly 20. In another present example, the number of heater rod openings in the assembly water inlet block (and the total number of assembly heater rods) can be a number other than three (3), and can preferably be a number totaling a factor of three (3), (e.g., 6, 9, 12, etc., heater rod openings with a similar number of associated heater rods, etc.).

Assembly water inlet block 26 further comprises an assembly water inlet block opening flanges 25a, 25b, 25c at each assembly water inlet block opening. At the opposing side of the water inlet block, the opening flange is dimensioned to receive and otherwise contact inner tubes in position within a respective outer tube, as disclosed herein. FIG. 3A further shows assembly water inlet block 26 further comprising an assembly water inlet 26a positioned along an edge (that can be a “topside” or “underside” edge depending on the selected orientation of the assembled inline water heater assembly and the selected position of water heater assembly within, for example, a beverage maker). As further shown in FIG. 3A, the assembly water inlet block 26 can be dimensioned to receive assembly water inlet fitting 27 at the assembly water inlet 26a.

Although not shown in FIG. 3A, assembly water inlet fitting 27 can be placed in communication with a water supply via a water line that can be a water supply line in communication with the water supply, such that a volume of water, for example, in the form of a water flow from a water supply can be directed (e.g., directed under a selected pressure and flow rate provided to a water flow by a pump, a vacuum, etc.) into and can otherwise enter the inline water heater assembly at the assembly water inlet of the assembly water inlet block. As described herein in greater detail and shown at least in FIGS. 4, 5A, 7A, 7B, 8A, 8B herein, assembly water inlet block 26 comprises an assembly water inlet block internal pathway established within the thickness of the assembly water inlet block that is configured to allow passage and circulation of a water flow repeatedly into, therethrough, and out from, selected locations of the assembly water inlet block.

Returning to FIG. 3A, when assembled, inline water heater assembly 20 forms a water-tight assembly that is sealed internally with, and that otherwise comprises, one or more O-rings dimensioned to provide a water-tight seal and water-tight sealing between adjacently positioned assembly components. As shown in FIG. 3A inline water heater assembly 20 further comprises a tube assembly 30 that in turn comprises, as shown in FIG. 3A, a plurality of outer tubes 32a, 34a, 36a having outer tube inner surfaces 32b, 34b, 36b and outer tube outer surfaces 32c, 34c, 36c. As shown in FIG. 3A, outer tubes are substantially cylindrical and substantially linear along their length, and outer tubes have an inner diameter, D1, that is substantially constant along their length.

According to present aspects, each of the outer tubes 32a, 34a, 36a are dimensioned to receive (e.g., in a close tolerance fit that can be a releasable frictional fit that can also be a substantially water-tight fit) a corresponding inner tube. As shown in FIG. 3A, the tube assembly 30 can be a multi-piece tube assembly that comprises multiple tube assemblies each comprising two tube types, for example: 1) an outer tube; and 2) an inner tube.

The outer tubes 32a, 34a, 36a can be made from a material that can be a refractive or other material that can be a heat insulating or other heat-resistant material, and that can also be a material configured to redirect and otherwise radiate and redirect heat impacting the outer tube inner surfaces inwardly from the outer tube inner surfaces. In one example, the outer tubes have an insulative thermal conductivity value ranging from about 16.2 W/m-k to about 121 W/m-K. In one example, the outer surface of the outer tube, in operation, reaches a temperature of less than about 100° F.

In one example, the present inline water heater assembly does not require an outer casing or housing that could be otherwise required for safety purposes, and that could add or be a source of an additional weight to the overall assembly. That is, according to present aspects, the outer surface of the outer tubes can remain “exposed” to an eternal assembly environment existing within, for example, a beverage maker incorporating the present inline water heater assembly. According to present aspects, the outer tube outer surfaces are configured to have a temperature at the outer tube outer surface equal to or less than about 140° F. to about 180° F. when the inline water heater assembly is in operation. Obviating the need for a water heater assembly outer casing for safety and/or safe handling and/or safe operation can further significantly reduce the weight and complexity of the assembly and provide further significant present advantages.

According to present Aspects, the outer tubes can be made from material that can be considered to be “food safe” materials that can withstand pressures at elevated temperatures and that, at the same time, will not convectively dissipate heat to the ambient air surrounding the heater block. Presently contemplated “food safe” materials can comprise stainless steel and need not be limited to only metallics, provided the selected outer tube material can withstand the temperatures and pressure required by aerospace regulations for such assemblies.

FIG. 3A further shows a plurality of inner tubes 42a, 44a, 46a having inner tube inner surfaces 42b, 44b, 46b and inner tube outer surfaces 42c, 44c, 46c, with the inner tubes dimensioned to be received by and assembled into the respective outer tubes in a close tolerance fit that can be removable and that can be a frictional fit, for example. The inner tubes each further comprise a directional channel 48 located at, and established by, the configuration of the inner tube outer surface. FIG. 3A shows directional channel 48 comprising and at least partially bounded by directional channel walls 48a, with the directional channel walls 48a comprising an outer edge or “top” region referred to herein as the directional channel wall outer edge 48b, with the directional channel 48 further at least partially bounded by a directional channel base 48c.

As shown in FIG. 3A, the directional channel 48 can be configured in a “spiral” or substantially spiral or other non-linear configuration continuing about the inner tube outer surface that is referred to equivalently herein as a “helical” directional channel configuration. The directional channel walls 48 can be integral with the inner tube outer surface and therefore can be made from the same material selected for use as the inner tube. In another example, the directional channel wall can be a material different from the material selected for the inner tube. The material or materials selected for fabricating the inner tube are highly heat conductive materials, and can be, for example, metals, metal alloys, including copper/aluminum alloys, with the material selected for the inner tubes having, according to one example, a thermal conductivity value ranging of about 390 W/m-K.

The inner tubes further comprise an inner tube inner diameter, D2, and an inner tube outer diameter, D3. See FIG. 3B. In one example, the inner tube outer diameter is established at the directional channel wall outer edges 48b of the directional channel wall 48a about the outer circumference of the inner tube. That is, inner tube outer diameter, D3, is the distance between a first directional channel wall outer edge at one side of the inner tube and a second directional channel wall outer edge 48b positioned at the inner tube outer surface positioned 180 degrees from the first directional channel wall outer edge 48b. According to present aspects, the inner tube outer diameter, D3, is substantially equivalent to the outer tube inner surface diameter, D1. The inner tubes 42a, 44a, 46a, are substantially cylindrical and substantially linear along their length, and the inner tubes have an inner tube outer diameter, D3, that is substantially constant along the length of the inner tube.

As shown in FIG. 3A, according to present aspects, the present inline water heater assembly 20 comprises the tube assembly 30 comprising an inner tube received into an outer tube, with the inner tube outer diameter D3 dimensioned and otherwise configured to be substantially equivalent to the outer tube inner diameter D1, with a portion of the outer tube inner surface configured to “seal” or otherwise provide a structural and substantially water-tight boundary for the directional channel 48 on the inner tube outer surface when the inner tube is inserted into the outer tube with the close tolerance fit (e.g., the fit between the outer tube inner surface having the diameter D1 and the inner tube outer surface having the diameter D3). As stated herein, the fit between the inner tube and outer tube can be a releasable frictional fit that can also be a substantially water-tight fit.

FIG. 3A further shows a plurality of heater rods 52a, 54a, 56a that are substantially cylindrical along their length and that are configured to be received snugly into the inner tubes 42a, 44a, 46a. That is, as shown in FIG. 3A, the heater rods have a corresponding heater rod outer surface 52b, 54b, 56b that will contact the inner tube inner surfaces 42b, 44b, 46b. In other words, heater rods 52a, 54a, 56a have an outer diameter D4 (as shown min FIG. 3C) that is substantially equivalent to the inner tube inner diameter D2. FIG. 3A further shows heater rods each comprising power cords 52e, 54e, 56e that can be fixedly attached in permanent or in a removably attachable configuration to the heater rods, with the power cords further in communication with a power source (not shown in FIG. 3A). In another example, when the present inline water heater assembly is integrated into and otherwise housed with, for example, a beverage maker or other hot water appliance, the heater rods may be powered directly from the appliance into which the heater assembly is integrated, including via direct contacts that may not incorporate a cord, or heater rod power cords may contact the appliance and be powered from the appliance such that the heater rods are in indirect communication with a power source, including a power source that can be external from the appliance, etc.

FIG. 3B is a cross-sectional end view into inner tube 42a, and showing the inner tube inner diameter D2 and inner tube outer diameter D3. As shown in FIG. 3B, the directional channel wall 48a is “topped” by the directional channel wall outer edge (“top”) 48b, with the inner tube outer diameter D3 measured from two opposing (e.g., 180° opposed) directional channel wall outer edges 48b (“tops”). The inner tube inner surface 42b of inner tube 42a is shown, with inner tube inner diameter, D2, shown as extending from locations at the inner tube inner surface 42b that are 180° opposed.

FIG. 3A further shows sets of O-rings (referred to equivalently herein as “O-ring seals”) that are configured and dimensioned to reside within and to provide water-tight seals to the inline water heater assembly (at least in an assembled state) between the assembly water inlet block (and outlet block) interfaces with the inner tube and outlet block at the associated outer tube ends and inlet tube ends to form water-tight seals. The assembly water inlet block 26 comprises assembly water inlet block recesses 25a 25b, 25c (equivalently referred to herein as assembly water inlet block flanges) that are configured to receive an inner tube O-rings 38a, 38b, 38c and outer tube O-rings 37a, 37b, 37c that will reside within assembly water inlet block recesses 25a 25b, 25c at or near the assembly water inlet block openings 24a, 24b, 24c. That is, according to present aspects, a water-tight seal between the inner tubes and the inlet block and outlet block is provided to the inline water heater assembly at least through the implementation of optimally placed inner tube O-rings. In addition, according to present aspects, a water-tight seal between the outer tubes and the inlet block and outlet block is provided to the inline water heater assembly at least through the implementation of optimally placed outer tube O-rings.

In the assembled state, the inner tube O-rings 38a, 38b, 38c and the outer tube O-rings 37a, 37b, 37c are configured, to contact, and are otherwise positioned at the respective water inlet block recesses: 1) between the inlet block and a first end of the inner and outer tubes; and 2) between the outlet block and a second end of the inner and outer tubes. The O-rings can be made from a resilient material that has an outwardly extending force in the presence of inwardly compressive forces and can be made from, for, example, plastics, rubbers, silicones, and combinations thereof.

In operation, the heater rods (referred to equivalently herein as “heating elements”) in the present water heater assemblies can reach a temperature ranging from about 150° F. to about 900° F. when power in the amount ranging from about 500 W to about 1500 W is delivered to the individual heater rods. Present aspects contemplate the present heater rods delivering the requisite heat to the inline water heater assembly inner tubes to produce a heated water flow exiting the inline water heater assembly at a heated temperature ranging from about 180° F. to about 205° F. within a comparatively very short heating time duration ranging from about 0.5 min to about 1.0 min, at least when the ambient temperature of the water flow entering the inline water heater assembly from a water supply has an ambient water temperature ranging from about 45° F. to about 100° F.

According to present aspects, the power source (referred to equivalently herein as a “power supply”) in communication with the heater rods can be a battery located onboard a vehicle including, for example, an aircraft. In another example, the power source can be a remotely-located power source (e.g., a battery). In another example, the power source can be integral with the inline water heater assembly heater rods, and/or the power source can be integral with a beverage maker that can also be in communication with and/or integral with the inline water heater assembly (that includes the heater rods). In another example, a power source can be in communication with, but not necessarily with both a beverage maker and the inline water heater assembly heater rods that are in communication with the beverage maker. According to further present aspects, the power source is derived from vehicle engine mounted generators or a vehicle auxiliary power unit (APU).

While the heater rods, the inner tubes, and the outer tubes are shown as substantially cylindrical in shape along their length, present aspects contemplate the three components having any longitudinal geometric shape along their length, so long as the three components are dimensioned to be assembled together and that, when assembled together, comprise a conforming adjacent fit with respect to at least the heater rods and the inner tubes, with adjacently located components in an assembled state having a fit of close tolerance and that can be easily disassembled from one another. That is, the heater rods, inner tubes, and outer tubes may have a rectangular, or hexagonal, or triangular, or other cross-sectional geometric shape, so long as they together form into an assembled state with virtually no space between and along the length of adjacent components in the assembled state, at least for purposes of forming a highly efficient heat transfer between the heater rods and the inner tubes, and such that the directional channels at the inner tube outer surface/outer tube inner tube interface provide a substantially water-tight seal for the water flow traversing and otherwise proceeding through the directional channel(s).

In addition, according to present aspects, the present inline water heater assembly can have a weld-free configuration that can significantly assist in the apparatus' assembly, and disassembly (e.g., for maintenance, component replacement, and/or inspection, etc.) For example, if only one heater rods requires removal/replacement and/or maintenance, individual heater rods can be replaced from and reinserted into the assembly, resulting in a significantly more cost-effective operation of the heater assembly. In addition, when the present inline water heater assembly is integrated into, for example, a beverage maker, the components of the heater assembly, being in a weld-free design, can be individually replaced and/or individually repaired, obviating the need for replacement of the entire beverage maker. In addition, when the water heater assembly is integrated into a beverage maker, the entire inline water heater assembly can be removed from the beverage maker.

According to further present aspects, the plurality of individual heater rods can exhibit a reduced total power draw ranging from about 2000 W to 2750 W; a power draw that is significantly less than a power draw of, for example, 2800 W that typical heating elements can demand for the beverage-making purposes (e.g., within an aircraft). In addition, the plurality of heater rods can comprise 3-phase power lines that can each direct power in the amount of 115V, 400 Hz to the individual heater rods. In another example, the three heater rods as shown in the FIGs. can be configured to each deliver the same heat to the assembly. In another example, the three individual heater rods can be configured to each deliver to the assembly differing amounts of heat from one another.

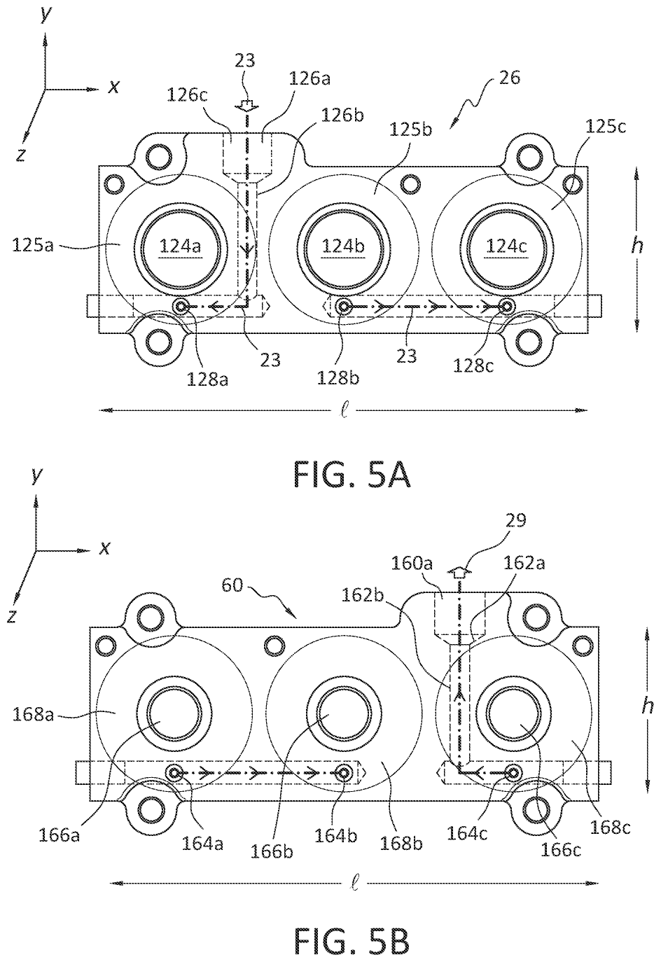

The inline water heater assembly 20, as shown in FIG. 3A further comprises an assembly water outlet block 60 (shown in detail in FIG. 5B), and referred to equivalently herein as an “end block”, that is configured to release a heated water flow from the water heater assembly outlet of the inline water heater assembly to a beverage maker. Assembly water outlet block 60 can comprise spaced openings through the thickness of the assembly water outlet block, at least for reducing weight of the outlet block, and also can act as “vents” to release heat from the heater rods in the event of heater rod overheating. The outlet block can further comprise assembly water outlet block opening flanges that can be dimensioned to receive, in an intimate fit that can be a water-tight fit (with inserted O-rings, or with applied sealant) the outer tubes in the inline water heater assembly when in the assembled and operational state.

FIG. 3A also shows tie rods 70 configured to secure the outer tubes, inner tubes, and “start” block and “end” block of the inline water heater assembly 20 when the assembly is in the assembled state; with tie rod screws 72 configured to be received by the tie rods 70 with the tie rods 70, for example, comprising internal threading at both ends configured to receive complementary threads the tie rod screws 72 in a fastened and secure state. Sealing screws 74 are shown, with sealing screws configured to be received into “start” and “end” blocks to “plug” drill access holes in communication with the internal pathways machined into the inlet and outlet blocks.

While FIG. 3A shows a disassembled inline water heater assembly having the assembly water inlet (“start”) block located at the end of the assembly where the heater rods are inserted, present aspects further contemplate the reversal of the positions in the assembly of the water inlet (“start”) block and the water outlet (“end”) block. Indeed, to illustrate another present example, FIG. 4 shows a disassembled inline water heater assembly, according to present aspects, where the inlet and outlet water blocks are reversed in position as compared to their relative positions to one another in the assembly as shown in FIG. 3A.

FIG. 3D shows an exploded view of an alternate inline water heater assembly 120, according to present aspects. Many of the numbered elements present in the assembly 20 shown in FIG. 3A are shown in FIG. 3D, with the main difference being that the alternate assembly 120 shown in FIG. 3D contemplates the addition and use of a of sealant material that can be a silicone sealant material (rather than O-rings) in the assembly 120 in the assembled state to effect a selected water-tight seal.

FIG. 3D further shows a plurality of heater rods 52a, 54a, 56a further comprising respective heater rod spacers 52c, 54c, 56c dimensioned to maintain the associated heater rod in fixed and removable position within respective inlet block openings 24a, 24b, 24c. FIG. 3D further shows a heater rod retainers 52d, 54d, 56d, associated with a respectively numbered heater rod 52a, 54a, 56a with the heater rod retainers dimensioned to fit within inlet block openings 24a, 24b, 24c. When the heater rod retainers are in position the heater rod retainers are configured to provide an outward force within the inlet block opening to retain the heater rods within the in line water heater assembly in the assembled state.

FIG. 4 shows a different perspective of the exploded view of the present inline water heater assembly 20 (as compared to the view of assembly 20 shown in FIG. 3A, for example) in a disassembled or pre-assembled state with directional arrows included to illustrate the direction of a water flow through the assembly 20. As shown in FIG. 4, a water flow 23 that is the “cooler” water flow, or “ambient temperature” water flow is provided to the inline water heater assembly 20 from a water supply (water supply is not shown in FIG. 4). According to present aspects, the water supply can be contained in a container, for example, a vehicle potable water tank that can be an aircraft potable water supply in an aircraft, with the water supply having an “ambient” temperature. In one example, the ambient temperature of the water supply and initial water flow can range from about 45° F. to about 100° F. After being heated through recirculation back-and-forth within the inline water heater assembly, the now heated water flow 29 can be released from, and can otherwise exit the inline water heater assembly 20 from the assembly outlet 67 into an integrated beverage maker or can be released from the water heater assembly to a discrete beverage maker as a heated water flow 29 that now has a rapidly elevated “hot” or “heated” temperature ranging from about 180° F. to about 205° F., and that can be a water temperature selected for, and suitable for making heated beverages from a beverage maker, for example.

The inner and outer tubes in FIG. 4 correspond to those shown in FIG. 3A, with present assembly components assigned common identifying numbers. As shown in FIG. 4, the incoming ambient temperature water flow 23 proceeds within assembly water inlet block 26 through assembly water inlet block internal pathway (shown in FIG. 5A as “126b”) and emerges through assembly water inlet block internal pathway outlet (shown in FIG. 5A as “128a”), where the water flow is directed into directional channel 48 of the inner tubes 42a, 44a, 46a. The water flow remains within and proceeds along the directional channel 48 along the length of the inner tube 42a (with directional channel bounded in part by outer tube inner surface 32b along the length of outer tube 32a into which inner tube 42a “fits” in a water-tight configuration, with a portion of the outer tube inner surface proximate to direction channel 48 acting as a part of the boundary of directional channel 48). The water flow then proceeds within the inline water heater assembly from the directional channel of the first inner tube and enters the assembly water outlet block 60 at assembly water outlet block internal pathway inlet (shown in FIG. 5B as “164a”) located at the entry “end” of assembly water outlet block internal pathway (shown in FIG. 5B as “162b”).

The water flow then travels within the internal pathway within the assembly water outlet block 60 and emerges from the assembly water outlet block pathway outlet (shown in FIG. 5B as “164b”) at a location where the water flow is redirected in a changed direction back through the inline water heater assembly 20, as the admitted water flow 23 continues to be heated to a final selected temperature by the assembly, and with the water flow next entering the directional channel 48 at the exterior surface of (the middle, or “second”) inner tube 44a and proceeds toward (e.g., “back” toward) and into the assembly water inlet block pathway (shown in FIG. 5A as “126”) of assembly water inlet block 26 at assembly water block internal pathway inlet (shown in FIG. 5A as “128b”). The water flow 23 continues to increase in temperature from the admitted water flow ambient temperature while the water flow is resident within the directional channel 48 of middle tube 44a of the inline water heater assembly 20.

As further shown in FIG. 4, the water flow then again travels (e.g., “recirculates within assembly 120”) within a section of the internal pathway 126b within the assembly water inlet block 126 and emerges from the assembly water inlet block pathway outlet 128c where the water flow enters the directional channel 48 at the exterior surface of inner tube 46a (e.g., the “third” inner tube) and proceeds once again toward and into the assembly water outlet block 160 at assembly water outlet block internal pathway inlet 164c, with the water flow 23 continuing to increase in temperature while the water flow is resident within the directional channel 48 at the outer surface of inner tube 46a of the inline water heater assembly 120. At this point in the water heating process, the water flow has been rapidly heated in a short time duration, according to present aspects, from an ambient water supply temperature to a heated temperature ranging from about 180° F. to about 205° F., with the heated water flow ready for release from the inline water heater assembly 120 at the inline water heater assembly outlet 162c (shown in FIG. 4 as) coinciding with assembly water outlet block outlet 160a.

An assembly water outlet fitting of the type shown as assembly water outlet fitting 67 in FIGS. 3A, 4 can be dimensioned and otherwise configured to fixedly attach or fasten by a, for example, a threaded joint, etc., to the assembly water outlet block outlet 60a.and that can be in communication with, for example, automated programming, etc., at least for the purpose of regulating the release (e.g., that can be an automated and/or an automatically regulated release, etc.) of the heated water flow 29 to, for example, a beverage maker into which the present inline water heater assembly is integrated. In another example, the outlet fitting 67 can further be in communication with tubing (e.g., heat-insulated tubing or uninsulated tubing (e.g., metallic or non-metallic tubing, etc.) that places the inline water heater assembly in communication with, for example, a beverage maker configured to receive the heated water flow released from the inline water heater assembly.

According to present aspects, in combination, the directional channels that are established at the inner tube outer surface and that are at least partially bounded by the outer tube inner surface locate “above” and proximate to the inner tube outer surface outer edges, are dimensioned to have a total volume, in further combination with the “start” block pathway volume and in combination with the “end block internal pathway volume that is very small and that ranges in total volume from about 10 ml to about 25 ml. In another example, the total volume of water contained in the entire assembly at any one moment can total from about 20 ml to about 25 ml (e.g., about 1 fluid ounce). The physical length of the assembly, and of the inner tubes comprising the directional channels also contributes to the overall available volume of the directional channels in the present inline water heater assembly. That is, in one example, present aspects contemplate an inner tube length of about four (4) inches in length with directional channels configured to have a total small volume (e.g., a water flow ranging from about 10 ml to about 25 ml) to be heated in the inline water heater assembly from an ambient temperature (ranging from about 45° F. to about 100° F.) to a heated water temperature (ranging from about 180° F. to about 205° F.) within a rapid time duration ranging from about 0.5 to about 1.0 minute. In another example, the time duration is about 0.5 min.

According to present aspects, the present inline water heater assembly is configured to deliver and/or dispense to a beverage maker a temperature-consistent water flow at a temperature ranging from about 180° F. to about 205° F. The term “temperature-consistent” means that, according to a present example, the dispensed water flow from the present inline water heater assembly can be a continuous flow, as needed for either: 1) a single beverage cup volume; and/or 2) a larger volume of a vessel or chamber that can be, for example, a carafe and/or an internal beverage maker chamber (e.g., a tank, etc.) at a temperature ranging from about 180° F. to about 205° F., with the vessel or chamber having a volume capacity ranging from about 1 to about 2 liters at a temperature, and within a time duration ranging from about 3 min. to about 4 mins.

That is, according to present aspects, when a larger volume dispensing cycle for a vessel and/or chamber is selected, the present inline water heater assembly is configured to deliver and/or dispense a temperature-consistent water flow at a temperature ranging from about 180° F. to about 205° F. at a flow rate of about 1 liter per 2 min., and with the present inline water heater assembly configured to deliver and/or dispense the substantially temperature-consistent water flow substantially continuously during the dispensing cycle (e.g., “substantially continuously” meaning without incurring a heated water flow interruption or cessation during the dispensing cycle, etc.).

FIGS. 5A and 5B are enlarged, partial cross-sectional end views of the “start” block 26 (referred to equivalently herein as an “assembly water flow inlet block” and “assembly water inlet block”) and “end” block 60 (referred to equivalently herein as an “assembly water flow outlet block” and “assembly water outlet block”). The assembly water flow inlet block 26 and the assembly water flow outlet block 60 each have a dimensional length “1” along their x-axis and a dimensional height “h” along their y-axis as shown in FIGS. 5A, 5B. Additionally, not shown in FIGS. 5A and 5B, the assembly water flow inlet block 26 and the assembly water flow outlet block 60 each have a dimensional width “w” along their z-axis (referred to equivalently herein as the “thickness” T1, T2 of the start block 26 and the end block 60 and shown in FIGS. 3A, 3D).

FIGS. 5A and 5B show an example of the internal pathway and directional water flow within the internal pathways of the “start” and “end” blocks of the types described herein and shown at least in FIGS. 3A, 4, 6A, 6B, 7A, 7B, 8A, and 8B, and according to present examples. Consistent with the descriptions herein, FIG. 5A shows an example of a present assembly water inlet block (e.g., “start” block) 26 accepting a water flow 23, for example from a water supply, that can be delivered from a water supply to the assembly water inlet block 26 at an water flow ambient temperature, or that can be a preheated initial water flow that can be introduced into an inlet fitting (not shown in FIG. 5A) of and into the assembly water inlet block 26 at the assembly water inlet block internal pathway first end 126c that can be considered substantially coincident in location with the assembly water inlet 126a. The assembly water inlet 126a can be dimensioned to receive an assembly water inlet fitting 27 (not shown in FIG. 5A).

FIG. 5A shows a plurality of assembly water inlet block openings 124a, 124b, 124c each configured and dimensioned to receive and secure a heater rod (e.g., openings into and out from the thickness of the assembly water inlet block and along the z-axis), with each opening surrounded by a corresponding assembly water inlet block opening flange 125a, 125b, 125c.

The assembly water inlet block 26 further comprises an assembly water inlet block internal pathway 126b within the thickness or width of the assembly water inlet block 26. As shown in FIG. 5A, the assembly water inlet block internal pathway 126b in assembly water inlet block 26, is in communication with a plurality of assembly water inlet block internal pathway outlets 128a, 128c and an assembly water inlet block internal pathway inlet 128b that extend from the pathway 126b along the z-axis (e.g., in a directional pathway laterally inward from the inlet to the pathway, and laterally “outwardly”, from the start block internal pathway to a start block internal pathway outlet, along the z-axis, and through a portion of the “width”, or “thickness” of the start block 26).

Present aspects are not limited to the number of pathway inlets and pathway outlets can be present in a “start” block or “end” block, so long as the orientation of block pathway inlets and block pathway outlets with respect to the internal block pathways is an orientation that is configured to establish a continuous directional water flow pathway (e.g., “back and forth”) from a start block internal pathway 26 into the tube assembly within and along the length of the directional channel, with the water flow then proceeding from the tube assembly directional channel into the internal pathway of the end block 60, and then proceeding from an end block internal pathway outlet back into the directional channel of the tube assembly, and then proceeding from the directional channel back into the an internal pathway of the start block 26, for repeated recirculation cycles of a water flow through each of the tube, and with the internal pathways in the start and end block configured to receive the water flow, change the direction of the water flow in the block internal pathway, and then direct the water flow out of the block internal pathway and into the directional channel of the “next” tube assembly. (and as shown, for example, at least in FIGS. 3A, 4).

In one example of the water flow through the assembly of the present apparatuses and systems, and referring to both FIG. 5A and FIG. 4, one possible configuration of the water flow 23 through the internal pathway of the “start” block 26 can be as follows. A water flow 23 is introduced at an ambient temperature, for example, from an ambient temperature ranging from about 45° F. to about 100° F., to the “start” block inlet 26a, 126a of “start” block 26 with the water flow directed through the internal pathway 126b and out of “start” block pathway outlet 128a to helical directional channel 48 of inner tube 42a. Water flow 23 continues through the helical directional channel 48 of inner tube 42a toward and into the assembly water outlet internal pathway 162b of the assembly water outlet block 60 (the “end” block). The water flow is then directed from the assembly water outlet block internal pathway 162b along the z-axis out of the “end” block and back into helical directional channel 48 of the second inner tube 44a (e.g., the “middle inner tube as shown in FIG. 4) and back to the “start” block 26 at “start” block pathway inlet 128b. Water flow 23 then proceeds through the “start” block internal pathway 126b and leaves “start” block 26 via “start” block internal pathway outlet 128c to the directional channel 48 of inner tube 46a (the “third” inner tube).

Consistent with the descriptions herein, FIGS. 4 and 5B show an example of a present assembly water outlet block (e.g., “end” block) 60, having a water flow 23 that can be introduced to and exit from the assembly water outlet block from and to the directional channels located along inner tube outer surfaces, and with a progressive and increasingly heated water flow (e.g., heated from an ambient temperature up to a heated temperature ranging from about 180° F. to about 205° F.) configured to be released from and exit the assembly inline water heater assembly from the assembly water outlet block outlet 60a, 160a.

As shown in FIG. 5B, outlet block 60 comprises the inline water heater assembly outlet 162a that can substantially coincide with the assembly water inlet block internal pathway end 162c and can be equivalently referred to as the overall assembly water outlet block outlet 160a. The assembly water outlet 160a can be dimensioned to receive an assembly water outlet fitting 67 (not shown in FIG. 5B; shown at least in FIGS. 3A, 4 as assembly water outlet fitting 67).

FIG. 5B further shows a plurality of assembly water outlet block openings outlets 166a, 166b, 166c each configured and dimensioned to receive and secure a heater rod (e.g., openings through the thickness of the assembly water outlet block), with each opening surrounded by a corresponding assembly water outlet block opening flange 168a, 168b, 168c. FIG. 5B further shows the assembly water inlet block internal pathway 162b in assembly water outlet block 60, with the assembly water inlet block internal pathway 162b in communication with a plurality of assembly water outlet block internal pathway inlets 164a, 164c and an assembly water outlet block internal pathway outlet 164b. As stated herein, present aspects are not limited to the number of pathway inlets and pathway outlets in a “start” or “end” block, so long as the orientation of block pathway inlets with respect to block pathway outlets is configured to establish a continuous directional pathway (e.g., “back and forth”) along the length of the plurality of inner tube outer surface directional channels as shown, for example, in FIGS. 3A, 4.

In one example of the water flow through the present assembly, and referring to FIG. 5B, one possible configuration of the water flow 23 through the internal pathway of the assembly water outlet (“end”) block 60 can be as follows. Water flow 23 from directional channel 48 of inner tube 42a is received into “end” block 60 at “end” block internal pathway inlet 164a along the z-axis. Water flow 23 then travels through “end” block internal pathway 162b and is directed from “end” block internal pathway outlet 164b along the z-axis into directional channel 48 of inner tube 44a (e.g., the middle tube). After passing through assembly 20, the progressively heated water flow 23 after re-entering the “start” block and being redirected from the start block back into the directional channel of the “next” inner tube, is then received back into the “end” block internal pathway at “end” block internal pathway inlet 164c along the z-axis from directional channel 48 of inner tube 46a and is directed out from assembly 20 and out from “end” block outlet 160a, and can be directed to and otherwise introduced to an associated (e.g., incorporated, integral, integrated, etc.) beverage maker as a rapidly heated water flow 29 having a heated water flow temperature ranging from about 180° F. to about 205° F.

The assembly water inlet (“start”) block and assembly water outlet (“end”) block can be made from a selected heat insulative material that can be a heat-insulative light-weight material, with the material selected to contribute to the heater assembly efficiency by not allowing a heated water flow to cool, or have associated water flow heat absorbed by the assembly water inlet and outlet blocks, for example. Accordingly, the “start” and “end” blocks can be manufactured according to a selected method (and can include, for example, additive manufacturing, drilling, etc., to fabricate the internal pathway during manufacture), and the blocks can be made from a refractive or other material that can be a heat insulating or other heat-resistant material, and that can also be a material configured to redirect and otherwise radiate and redirect heat impacting the inlet and outlet blocks inwardly toward the inlet and outlet block internal pathways, for example.

In one example, the inlet and outlet blocks can be made from a material having an insulative thermal conductivity value ranging from about 16.2 W/m-k to about 121 W/m-K. In one example, the outer surfaces of the inlet and outlet blocks, in heater assembly operation, can reach a temperature of less than about 100° F. In one example, the maximum temperature of the inlet and outlet end blocks will not exceed about 212° F. The surface temperature at the inlet and outlet end blocks can be used as a limit for overheat protection of the heater block assembly. For example, the inlet and/or outlet block temperature can be sensed by a thermostat that, for example, “opens” if the surface temperature of the inlet and outlet blocks ever exceeds a selected temperature limit. The thermostat can be in communication with controllers, or can itself be configured to shut down power to the heating elements, for example.

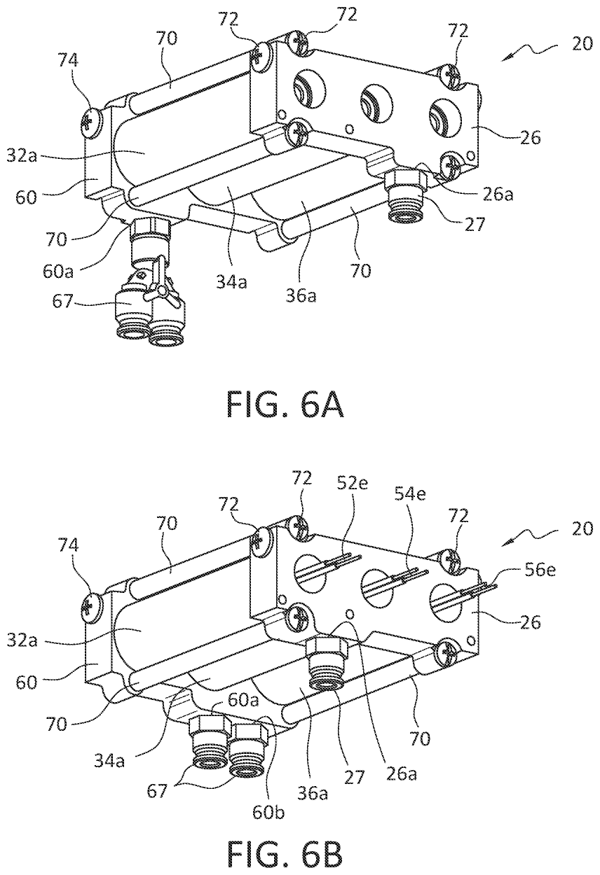

FIGS. 6A and 6B are each perspective views of the present inline water heater assembly 20 of the type shown in, for example, FIG. 3A, 4 (and that can be representative of the types of present inline water heater assemblies shown and described herein), that is now in an assembled configuration (and inverted as compared with the view shown in FIG. 3A, 4), and with visible parts of the assembled inline water heater assembly 20 numbered similarly to the numbered parts shown in FIG. 3A, 4. In FIG. 6A, the incorporated heater rods positioned within the inner tubes present in assembly 20 are not visible. FIG. 6A water heater assembly component orientation in the assembled state of the assembly comports with the exploded views shown in FIGS. 3A, 4, where the heater rods can be inserted into position in the assembly through the opening in the outset block 60.

In FIG. 6A, the assembly water outlet fitting 67 is shown attached to a single outlet “port” shown at the assembly water outlet block outlet 60a of outlet block 60. The assembly water outlet fitting 67 is a dual outlet fitting that can comprise a valve that can be switched between positions with the dual outlet fitting configured to release a single heated water flow from assembly 20 from either and/or both of the outlets of the dual outlet fitting. In another example, the valve in the dual outlet fitting can be moved to an “off” position to block the release of the heated water flow from the inline water heater assembly 20. The dual outlet fitting can be operated manually. Although not shown in FIG. 6A, in another example, the dual outlet fitting can be operated automatically and or remotely with the dual outlet fitting comprising or in communication with a receiver and/or a controller, with the receiver configured to receive a transmitted signal from a transmitter and/or a controller for the purpose of altering, terminating, and/or releasing a heated water flow from assembly 20 upon command, and in real time, during a heated water dispensing regimen or draining regimen, etc.

In FIG. 6B, a further variation is shown with the inline water heater assembly 20 comprising two assembly water outlet fittings 67 attached to and extending from assembly water outlet block 60 at assembly water outlet block outlets 60a, 60b positioned within the inner tubes present in assembly 20 are not visible. In addition, the incorporated heater rods are in position within the water heater assembly 20 with the heats' power cords 52e, 542, 56e shown extending from assembly 20 in FIG. 6B. FIG. 6B is further intended to show that the position of the assembly water inlet 26a and the assembly water outlet(s) 60a can be positioned at varying selected non-limiting locations on the respective inlet and outlet blocks, with the positions of said inlets and outlets in assembly 20 as shown in FIG. 6B varying from the positions shown in FIG. 6A.

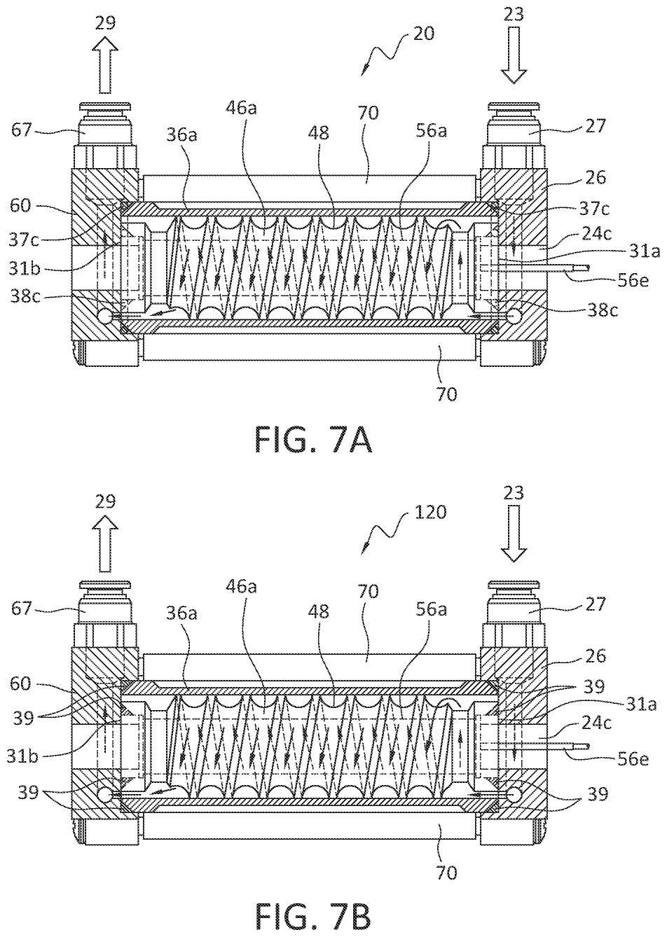

FIGS. 7A and 7B, respectively, are partial cross-sectional side views of the inline water heater assemblies 20, 120 in an assembled state, according to present aspects, and show similarly numbered parts to those shown in FIGS. 3A and 3D respectively. That is, FIG. 7A shows inline water heater assembly 20 that comprises inner and outer O-rings positioned and configured to provide sealing for the inner tube and outer tubes, with the inner and outer O-rings positioned between the ends of the inner and outer tubes and the assembly water inlet block and the assembly water outlet block.

FIG. 7B shows assembly 120 that can be of the type of assembly as shown in FIG. 3D (that is a variation of assembly 20), and where O-rings are not present in the water heater assembly and, instead, sealant is applied the assembly to form the seals between the ends of the inner and outer tubes and the assembly water inlet block and the assembly water outlet block. FIGS. 7A and 7B further illustrate the entry of ambient temperature water 23 introduced into the assemblies 20, 120, with the water flow heated within assemblies 20, 120, and with the heated water flow 29 exiting the water heater assemblies 20, 120.

FIGS. 7A and 7B are further intended to illustrate the direction water flow through the directional channel 48 established between the inner and outer tubes, with the “third” inner tube 46c and “third” outer tube 36a shown such that the directional channel 48 of inner tube 46a is in direct and proximate communication with the assembly water outlet block outlet 60a at the water heater assembly outlet 62a

FIG. 7A shows inline water heater assembly 20 comprising assembly water inlet block 26 and assembly water outlet block 60 in with inner tube 46a positioned in a water-tight fit within outer tube 36a and with directional channel 48 formed between the assembled inner and outer tubes. Heater rod 56a is positioned within inner tube 46a with heater rod power cord seen extending from assembly water inlet block opening 24c. The directional channel 48 is shown having a helical or “spiraling” configuration that establishes a flow path for the water flow within water heater assembly 20 as amounts of ambient temperature water 23 introduced to water heater assembly 20 is progressively heated within directional channel 48 to a selected heated water temperature, with the heated water flow 29 exiting the water heater assembly at the selected heated water temperature from assembly water outlet block fitting 67.

FIG. 7A further shows first and second ends of the outer tube contacting an outer O-ring 37c in positions between the outer tube 36a and the inlet block 26 and the outlet block 60. First and second ends of the inner tube are shown in FIG. 7A contacting an inner O-ring 38c in positions between the inner tube 46a and the inlet block 26 and the outlet block 60. Tie rods 70 are shown in position providing secure attachment and water-tight positioning of the components of assembly 20, with internal tie rod screw (not shown in FIG. 7A) providing the inwardly compressive force on the internal components of assembly 20 that, along with the O-rings can contribute to the water-tight (e.g., leakproof) condition of the inline water-heater assembly 20 in the assembled state.

As stated herein, FIG. 7B shows a present variation, according to present aspects, with inline water heater assembly of the type shown in FIG. 3D is in an assembled state, (and that is a variation of assembly 20), where O-rings are not present in the assembled state of assembly 120 and, instead, sealant is applied 39 is applied in the assembly 120 to form the seals between the ends of the inner and outer tubes and the assembly water inlet block and the assembly water outlet block. The sealant can be a silicone or other heat-resistant sealant compatible with the inner tubes, outer tubes, and water inlet and water outlet blocks. Applied sealants can be curable sealants that can cure within about 24 hours.

The O-rings inserted into the present assemblies to adjacent block openings, block opening flanges, and/or adjacent inner and outer tube ends using, for example, can themselves be replaced on a selected maintenance schedule. In addition, the use of O-rings in place of a silicone sealant material in the present weld-free assemblies can further facilitate maintenance and replacement of present individual component parts of the present inline water heater assembly.

In addition, according to present aspects, in between beverage maker uses, or when the beverage maker is no longer in use, water that is present in the water heater assembly in (e.g., when the beverage maker is not operational, etc.) can be drained from the assembly (e.g., by applying vacuum, back pressure, etc., to the system, or through gravity, etc.), at least for the purpose of further reducing the opportunity for developing deposits (e.g., metal deposits, etc.) that can cause a degree of “scaling” and/or that can otherwise interfere with or react with, for example, a metallic inner tube outer surface and/or outer tube inner surface in a way that could reduce an efficient indirect heat transfer from the heater rods to inner tube outer surface directional channels and further to a water flow being heated when the assembly is next in use, and/or affect beverage taste, quality, etc. In addition, such intermittent draining of water from the assembly between uses of the beverage maker can further ensure the delivery of a fresh-water flow to the beverage maker, as no “stagnant” water supply within the inline water heater assembly can occur, and only a delivery of freshly heated water flow occurs per individual beverage being dispensed from the beverage maker.

In the assembled state, the components visible in the assembled inline water heater assembly 20 can include the assembly water inlet block 26 (with inlet block fitting 27 and inlet block line water supply line (not shown in the FIGs.) that can extend from assembly water inlet fitting 27 of assembly water inlet block 26). In addition, an outlet block line water delivery line (not shown in the FIGs.) can extend from assembly water outlet fitting 67 of assembly water outlet block 60.

Present aspects further contemplate varying and otherwise adjusting the selected direction of an ambient temperature water flow introduced to the present inline water heater assemblies as the water is progressively heated in the assembly as the water proceeds through the directional channels along the length of the multiple outer tubes/inner tubes within the assembly. Further present aspects further contemplate varying the selected relative positioning of the inlet and outlet assembly blocks with respect to one another and with respect to an inlet or outlet block proximity to the heater rods, varying the selected directional orientation of the directional channels, varying the selected pressure applied to the water flow, varying the selected through-velocity of the water flow through the inline water heater assembly, and varying the selected number of outer tube/inner tube assemblies (and their dimensions), at least for the purpose of, for example, controlling/varying the flow rate of water into the water heater assembly, while still achieving the selected resultant overall heating of a water flow to a selected and useful beverage-making temperature ranging from about 180° F. to about 205° F. within a time duration ranging from about 0.5 to about 1.0 min.

While the physical configuration of the inline water heater assembly components can be varied, according to present aspects, the total water flow volume present within the blocks and directional channels of the tube assembly is maintained at a small volume ranging from about 10 ml to about 25 ml. of water (e.g., 0.75 to about 1.0 fluid ounce), and more preferably maintained at a small volume of water within the assembly (e.g., within the system at any one time, etc.) from about 20 ml to about 22 ml, or about 1.0 fluid ounce.

In addition, according to present aspects, the length of the water heater assembly in the assembled state that can be integrated within a beverage maker can be selected to be about 4.5 inches in total overall length. The compact profile and “footprint” of the present inline water heater assembly in the beverage maker can result in an inline water heater assembly that has a significantly reduced water heater weight, ranging from about 1.0 kg to about 1.5 kg. According to present aspects, the significantly reduced water heater assembly footprint can more easily be integrated into a beverage maker, and/or placed in communication or integrated within a hot water dispensing device. The smaller water heater footprint can reduce the footprint of a beverage maker footprint that can further save significant space in an enclosed environment, such as, for example, an aircraft galley of an aircraft, where available space is at a premium. In addition, in the case of an aircraft, the significant weight reduction of the present inline water heater assembly residing within and otherwise incorporated within a beverage maker can reduce the overall weight of an aircraft incorporating the present inline heater assembly, resulting in significant aircraft operational cost reduction, at least in terms of fuel, etc., and can result in extending aircraft range, and other operational advantages, etc.

The present inline water heater assembly provides heat to progressively supplied small volumes (about 10 ml to about 25 ml) of water provided to the water heater assembly in a constant water flow, with the small volume of heated water resulting in a water flow that is successfully and efficiently heated quickly from an ambient temperature water supply to a useful heated beverage-making water supply, as the water flow proceeds through the inline water heat assembly. That is, according to present aspects, a heat energy provided by a plurality of heater rods proceeds indirectly from the heater rods to the water flow to be heated “indirectly” and within the directional channels provided at the inner tube outer surface, with the heater rods providing a highly efficient heat transfer to the inline water heater assembly with the heater rods (e.g., the heating source) not directly contacting and not in direct communication with the water flow. In this way, the opportunity for potential decreased system heating efficiency that can typically occur in aircraft water heaters is avoided as there is no opportunity for “scaling” that typically occurs at heat source surfaces as, in presently disclosed operations, the heating elements indirectly heat a continuous low (e.g., small) volume of water in a continuous water flow, rather than directly heating a larger stagnant water volume held and heated within, for example, a vessel having a stagnant water volume of as much as 1.5 liter, as is typically done.

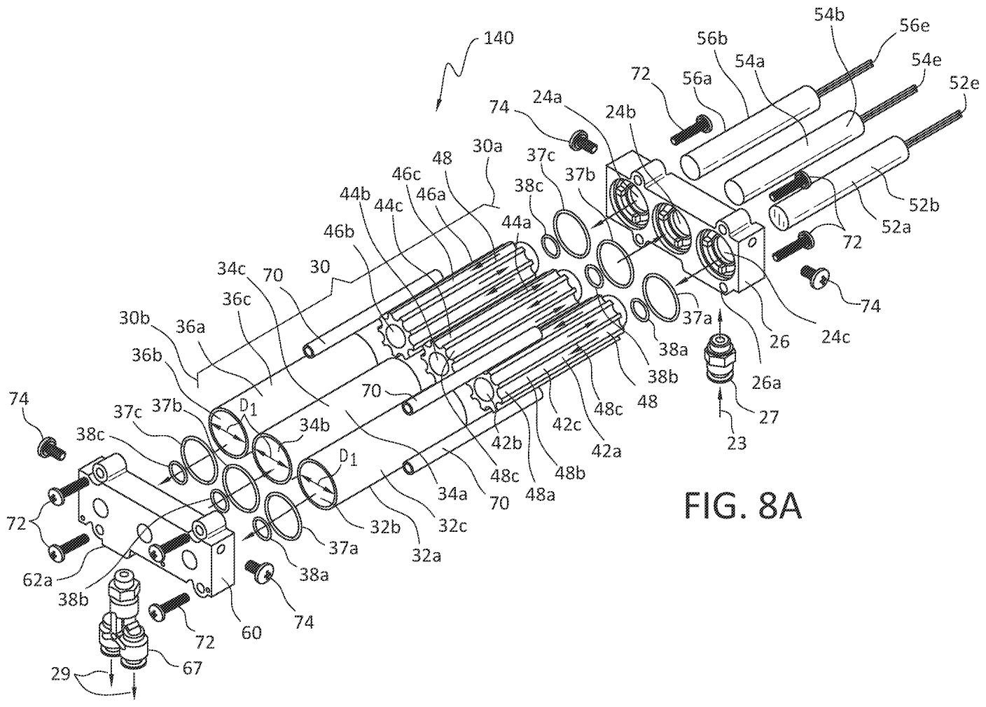

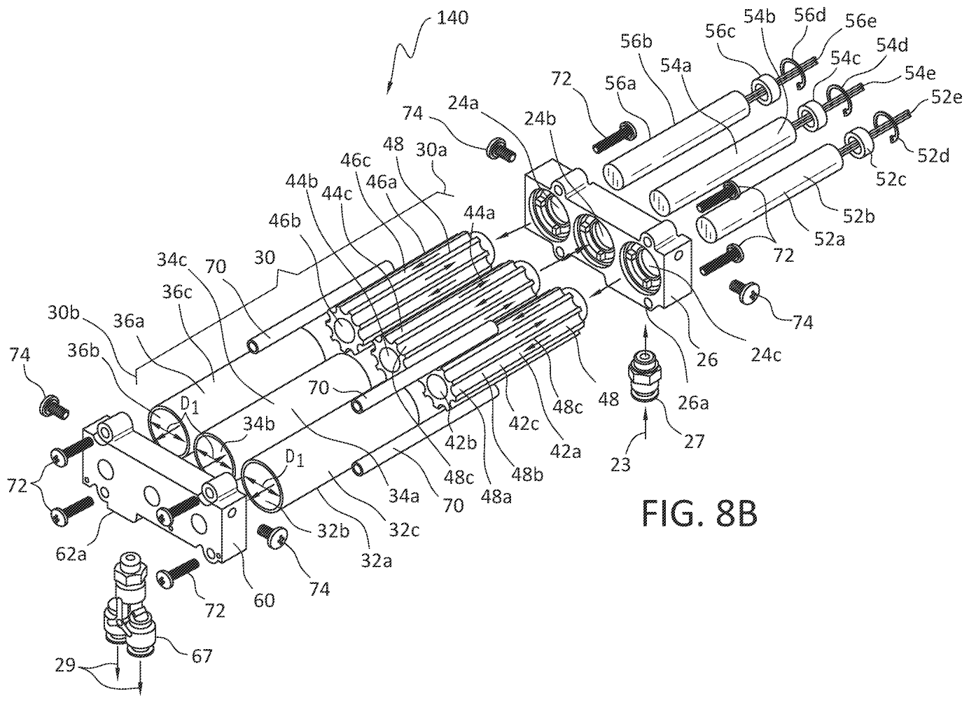

As mentioned herein, the directional channel at the outer surface of the inner tube can comprise a variety of orientations, and can be a helical directional channel, and in another example can be, for example, a plurality of linear directional channels configured to sequentially “channelize” a continuous small volume of water in a directed water flow within the inline water heater assembly from of a water supply. For example, FIG. 8 shows an alternate aspect of the present inline water heater assembly, with the outer surface of the inner tubes comprising directional channels that are linear.

FIGS. 8A and 8B are exploded views of a present inline water heater assembly 140, according to an alternate example and according to present aspects, with similarly numbered components as shown in FIG. 3A marked similarly. FIG. 8A shows an alternate aspect where the directional channels 48 located at the outer surfaces of inner tubes 42a, 44a, 46a are positioned linearly (e.g., in a substantially “straight” line). While the linear directional channels 48 (as opposed to the helical directional channel shown in FIG. 3A) may have reduced channel surface area over a fixed length as compared with helical directional channels. Present water heater assemblies employing linear directional channels can obtain a desired resulting heated water temperature within a slightly longer time duration, or may require more power draw to obtain heated water within a similar time duration as compared to the assemblies having the helical directional channels. If a water flow has a shorter overall resident time duration within the inline water heater assembly 140 as compared to the assemblies 20, 120 shown in FIG. 3A, 4, the power supplied to the heater rods, and/or a reduced pressure applied to the water flow (e.g., to regulate water flow velocity through the inline water heater assembly, etc.) can be selected and adjusted to account for such variations.

FIG. 8B shows assembly 140 that can be of the type of assembly as shown in FIG. 8A, and where O-rings are not present in the water heater assembly and, instead, sealant is applied the assembly to form the seals between the ends of the inner and outer tubes and the assembly water inlet block and the assembly water outlet block.

In one operational example, the present methods, systems, and apparatuses were configured to heat, within the present inline water heater assembly, a volume of an ambient temperature water flow from a water supply was directed to the present inline water heater assembly. A starting water flow into the present apparatuses having a starting ambient temperature of about 24.29° C. (74.7° F.) was directed into the present inline water heater assembly. Within a resident time duration within the present inline water heater assembly, the heated water flow exited the present inline water heater assembly in 37.04 seconds at a temperature of 90.19° C. (194.3° F.). After a duration of about 60 seconds, the water exiting the present inline water heater assembly was measured to have an exit temperature of about 98° C. (208.4° F.).

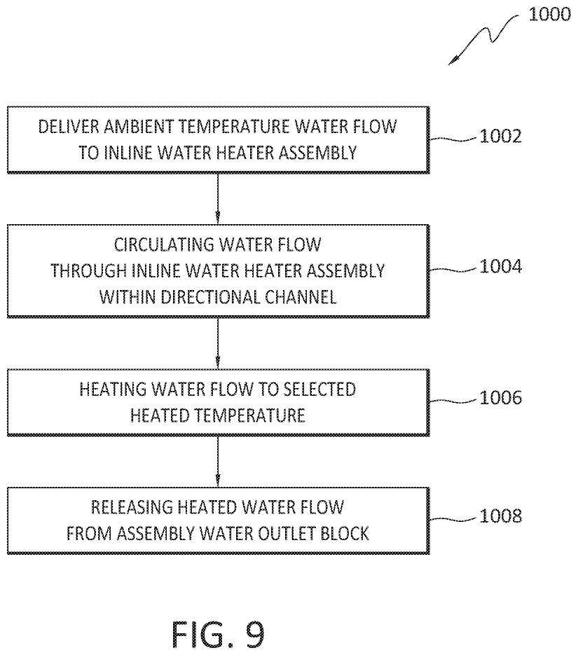

FIG. 9 is a method flowchart outlining present aspects. As shown in FIG. 9, a method 1000 includes delivering 1002 a portion of the water from the water supply maintained at an ambient temperature (an ambient temperature that, according to a present example, is an ambient temperature ranging from about 45° F. to about 100° F.) to an inline water heater assembly in the form of a water flow, with the inline water heater assembly including an inline water heater assembly in communication with the water supply. The inline water heater assembly includes an assembly water inlet block, with the assembly water inlet block comprising an assembly water inlet block thickness (T1), with the assembly water inlet block further comprising an assembly water inlet in communication with the water supply, with the assembly water inlet block further comprising an assembly water inlet block internal pathway, with the assembly water inlet block internal pathway comprising an assembly water inlet block internal pathway inlet pathway first end positioned adjacent the assembly water inlet, with the assembly water inlet block internal pathway further comprising at least one assembly water inlet block internal pathway inlet in communication with the directional channel of at least one inner tube, and with the assembly water inlet block internal pathway further comprising at least one assembly water inlet block internal pathway outlet in communication with the directional channel of at least one inner tube. The inline water heater assembly further includes a tube assembly in communication with the assembly water inlet block, with the tube assembly including a plurality of outer tubes, with each of the plurality of outer tubes including an outer tube inner surface and an outer tube outer surface, with each of the plurality of outer tubes further comprising an outer tube inner diameter (D1). The tube assembly further includes a plurality of inner tubes, with each of the plurality of inner tubes including an inner tube inner surface, and an inner tube outer surface, with each of the plurality of inner tube outer surface including a directional channel in communication with the assembly water inlet block internal pathway, with the directional channel including a directional channel wall including a directional channel wall outer edge, with the directional channel further including a directional channel base, with the directional channel base bounded by adjacent directional channel walls, and with the plurality of inner tubes comprising an inner tube inner diameter (D2), and an inner tube outer diameter (D3) extending between opposing directional channel wall outer edges that are positioned 180 degrees from one another, said inner tube outer diameter (D3) substantially equivalent to the outer tube inner diameter (D1). The inline water heater assembly further includes a plurality of heater rods in communication with a power source, with each of the plurality of heater rods comprising a heater rod outer surface and a heater rod outer surface diameter (D4), and with the heater rod outer surface diameter substantially equivalent to the inner tube inner diameter (D2). The inline water heater assembly further includes an assembly water outlet block, with the assembly water outlet block including an assembly water outlet block thickness (T2), and with the assembly water outlet block further including an assembly water outlet in communication with a beverage maker. The assembly water outlet block further includes an assembly water outlet block internal pathway, with the assembly water outlet block internal pathway including an assembly water inlet block internal pathway inlet pathway first end positioned adjacent the assembly water inlet, with the assembly water outlet block internal pathway further comprising at least one assembly water outlet block internal pathway inlet in communication with the directional channel of at least one inner tube, with the assembly water outlet block internal pathway further comprising at least one assembly water outlet block internal pathway outlet in communication with the directional channel of at least one inner tube. Method 1000 further includes circulating 1004 the water flow within the inline water heater assembly along the directional channel of each of the at least one inner tube at the inner tube outer surface to form a heated water flow, heating 1006 the heated water flow to a temperature ranging from about 180° F. to about 205° F., and releasing 1008 the heated water flow from the assembly water outlet block. The released heated water flow is then directed within the associated and integral beverage maker, wherein the water flow is heated within the inline water heater assembly from the ambient temperature ranging from about 45° F. to about 100° F. to a temperature ranging from about 180° F. to about 205° F. within a time duration ranging from about 0.5 min to about 1.0 min, and wherein said inline water heater assembly is configured to comprise a total volume within the inline water heater assembly ranging from about 10 ml to about 25 ml.

Method 1000 is understood to employ the apparatuses and systems described herein and shown at least in FIGS. 1, 2A, 2B, 3A, 3B, 4, 5A, 5B, 6A, 6B, 7A, 7B, 8A, and 8B.

The terms positioned “substantially”, “substantially adjacent”, “substantially equivalent”, “substantially housed within”, etc., as used herein means that a particular physical element is, for example, almost completely or is nearly completely positioned or adjacent to, equivalent to, and/or is nearly entirely housed within another stated element. In addition, the term “substantially equivalent” with respect to dimensions or characteristic values between elements being compared, are “nearly equivalent” dimensions or characteristic values and may not be exactly equivalent, etc.

The present aspects may, of course, be carried out in other ways than those specifically set forth herein without departing from essential characteristics of the present disclosure. The present aspects are to be considered in all respects as illustrative and not restrictive, and all changes coming within the meaning and equivalency range of the appended claims are intended to be embraced therein.

What is claimed:

1. An apparatus for heating a liquid for a beverage maker, said apparatus comprising:
an inline water heater assembly in communication with a water supply, the inline water heater assembly comprising:
an assembly water inlet block, said assembly water inlet block comprising:
an assembly water inlet block inlet in communication with the water supply;
an assembly water inlet block internal pathway, said assembly water inlet block internal pathway comprising;
one or more assembly water inlet block internal pathway inlets;
one or more assembly water inlet block internal pathway outlets;
an assembly water outlet block, said assembly water outlet block comprising:
an assembly water outlet block outlet in communication with the beverage maker;
an assembly water outlet block internal pathway, said assembly water outlet block internal pathway comprising:
one or more assembly water outlet block internal pathway inlets;
one or more assembly water inlet block internal pathway outlets;
a tube assembly comprising a tube assembly first end and a tube assembly second end, said tube assembly first end positioned adjacent to the assembly water inlet block, said tube assembly second end positioned adjacent to the assembly water outlet block, said tube assembly comprising:
a plurality of outer tubes, said plurality of outer tubes comprising an outer tube inner surface and an outer tube outer surface, said plurality of outer tubes further comprising an outer tube inner diameter;
a plurality of inner tubes, said plurality of inner tubes comprising an inner tube inner surface, and an inner tube outer surface, said inner tube outer surface comprising one or more directional channel, said one or more directional channel comprising a directional channel wall comprising a directional channel wall outer edge, said directional channel further comprising a directional channel base, said directional channel base bounded by adjacent directional channel walls, said directional channel bounded by said directional channel base, said directional channel walls and a portion of the outer tube inner surface, said plurality of inner tubes comprising an inner tube inner diameter, said inner tube further comprising an inner tube outer diameter extending between opposing directional channel wall outer edges that are positioned 180 degrees from one another, said inner tube outer diameter substantially equivalent to the outer tube inner diameter;
a plurality of heater rods, said plurality of heater rods comprising a heater rod outer surface and a heater rod outer surface diameter substantially equivalent to the inner tube inner diameter, one of said plurality of heater rods positioned within one of the plurality of inner tubes; and
wherein said one or more directional channel is in fluid communication with the assembly water inlet block internal pathway, said one or more directional channel is further in fluid communication with said assembly water outlet block internal pathway.

2. The apparatus of claim 1, further comprising a weld-free water-tight seal at a tube assembly first end/assembly water inlet block interface, and further comprising a weld-free water-tight seal at a tube assembly second end/assembly water outlet block interface.

3. The apparatus of claim 2, wherein the weld-free water-tight seal comprises at least one of a sealant material and an O-ring.

4. The apparatus of claim 1, wherein the inline water heater assembly is configured to contain a maximum total fluid volume ranging from about 10 ml to about 25 ml.

5. The apparatus of claim 1, wherein each of the one or more directional channel is a liner channel.

6. The apparatus of claim 1, wherein the one or more directional channel is a helical channel.

7. The apparatus of claim 1, wherein the one or more directional channel is a single helical channel.

8. The apparatus of claim 1, wherein the tube assembly and the heater rods are substantially cylindrical.

9. A beverage maker comprising the apparatus of claim 1.

10. A vehicle comprising the beverage maker of claim 9.

11. An aircraft comprising the beverage maker of claim 9.

12. A system for heating water in a beverage maker the system comprising:
a water supply;
an inline water heater assembly in communication with the water supply, the inline water heater assembly comprising:
an assembly water inlet block, said assembly water inlet block comprising:
an assembly water inlet block inlet in communication with the water supply;
an assembly water inlet block internal pathway, said assembly water inlet block internal pathway comprising;
one or more assembly water inlet block internal pathway inlets;
one or more assembly water inlet block internal pathway outlets;
an assembly water outlet block, said assembly water outlet block comprising:
an assembly water outlet block outlet in communication with the beverage maker;
an assembly water outlet block internal pathway, said assembly water outlet block internal pathway comprising:
one or more assembly water outlet block internal pathway inlets;
one or more assembly water inlet block internal pathway outlets;
a tube assembly comprising a tube assembly first end and a tube assembly second end, said tube assembly first end positioned adjacent to the assembly water inlet block, said tube assembly second end positioned adjacent to the assembly water outlet block, said tube assembly comprising:
a plurality of outer tubes, said plurality of outer tubes comprising an outer tube inner surface and an outer tube outer surface, said plurality of outer tubes further comprising an outer tube inner diameter;
a plurality of inner tubes, said plurality of inner tubes comprising an inner tube inner surface, and an inner tube outer surface, said inner tube outer surface comprising one or more directional channels, said one or more directional channel comprising a directional channel wall comprising a directional channel wall outer edge, said directional channel further comprising a directional channel base, said directional channel base bounded by adjacent directional channel walls, said directional channel bounded by said directional channel base, said directional channel walls and a portion of the outer tube inner surface, said plurality of inner tubes comprising an inner tube inner diameter, said inner tube further comprising an inner tube outer diameter extending between opposing directional channel wall outer edges that are positioned 180 degrees from one another, said inner tube outer diameter substantially equivalent to the outer tube inner diameter;
a plurality of heater rods, said plurality of heater rods comprising a heater rod outer surface and a heater rod outer surface diameter substantially equivalent to the inner tube inner diameter, one of said plurality of heater rods positioned within one of the plurality of inner tubes;
a power supply in communication with the plurality of heater rods; and
wherein said one or more directional channel is in fluid communication with the assembly water inlet block internal pathway, said one or more directional channel is further in fluid communication with said assembly water outlet block internal pathway.

13. The system of claim 12, wherein the power supply is configured to provide power to the plurality of heater rods at a wattage ranging from about 1500 W to about 2700 W.

14. The system of claim 12, wherein the water supply is configured to deliver a water flow from the water supply to the inline water heater assembly at an ambient water flow temperature ranging from about 45° F. to about 100° F., and wherein the water flow is configured to exit the inline water heater assembly as a heated water flow comprising a heated water flow comprising a temperature ranging from about 180° F. to about 205° F., with the water flow comprising a resident duration time in the inline water heater assembly ranging from about 0.5 to about 1.0 min.

15. The system of claim 12, wherein the inline water heater assembly is configured to contain a maximum total fluid volume ranging from about 10 ml to about 25 ml.

16. The system of claim 12, wherein the one or more directional channel is at least one of a liner channel and a helical channel.

17. The system of claim 12, wherein the one or more directional channel is a single helical channel.

18. A vehicle comprising the system of claim 12.

19. An aircraft comprising the system of claim 12.

20. A method for heating water for a beverage maker, the method comprising:
delivering a water flow from a water supply comprising an ambient temperature to an inline water heater assembly of the beverage maker, the inline water heater assembly comprising:
an assembly water inlet block, said assembly water inlet block comprising:
an assembly water inlet block inlet in communication with the water supply;
an assembly water inlet block internal pathway, said assembly water inlet block internal pathway comprising;
one or more assembly water inlet block internal pathway inlets;
one or more assembly water inlet block internal pathway outlets;
an assembly water outlet block, said assembly water outlet block comprising:
an assembly water outlet block outlet in communication with the beverage maker;
an assembly water outlet block internal pathway, said assembly water outlet block internal pathway comprising:
one or more assembly water outlet block internal pathway inlets;
one or more assembly water inlet block internal pathway outlets;
a tube assembly comprising a tube assembly first end and a tube assembly second end, said tube assembly first end positioned adjacent to the assembly water inlet block, said tube assembly second end positioned adjacent to the assembly water outlet block, said tube assembly comprising:
a plurality of outer tubes, said plurality of outer tubes comprising an outer tube inner surface and an outer tube outer surface, said plurality of outer tubes further comprising an outer tube inner diameter;
a plurality of inner tubes, said plurality of inner tubes comprising an inner tube inner surface, and an inner tube outer surface, said inner tube outer surface comprising one or more directional channel, said one or more directional channel comprising a directional channel wall comprising a directional channel wall outer edge, said directional channel further comprising a directional channel base, said directional channel base bounded by adjacent directional channel walls, said directional channel bounded by said directional channel base, said directional channel walls and a portion of the outer tube inner surface, said plurality of inner tubes comprising an inner tube inner diameter, said inner tube further comprising an inner tube outer diameter extending between opposing directional channel wall outer edges that are positioned 180 degrees from one another, said inner tube outer diameter substantially equivalent to the outer tube inner diameter;
a plurality of heater rods, said plurality of heater rods comprising a heater rod outer surface and a heater rod outer surface diameter substantially equivalent to the inner tube inner diameter, one of said plurality of heater rods positioned within one of the plurality of inner tubes;
circulating the water flow within the inline water heater assembly along the one or more directional channel of each of the at least one of the plurality of inner tubes at the inner tube outer surface;
heating to form a heated water flow, said heated water flow having a temperature ranging from about 180° F. to about 205° F.;
releasing the heated water flow from the assembly water outlet block;
wherein said water flow is heated within the inline water heater assembly from the ambient temperature ranging from about 45° F. to about 100° F. to a heated temperature ranging from about 180° F. to about 205° F. within a time duration ranging from about 0.5 min to about 1.0 min; and
wherein said inline water heater assembly is configured to comprise a total water volume of the water flow within the inline water heater assembly ranging from about 10 ml to about 25 ml.
